(19) United States
(12) Patent Application Publication
(10) Pub. No.: US 2010/0033570 A1
(43) Pub. Date: Feb. 11, 2010

(54) DRIVER OBSERVATION AND SECURITY SYSTEM AND METHOD THEREFOR

(76) Inventor: Morgan Plaster, Las Vegas, NV (US)

Correspondence Address: WEISS & MOY PC, 4204 NORTH BROWN AVENUE, SCOTTSDALE, AZ, 85251, US

(21) Appl. No.: 12/186,419

(22) Filed: Aug. 5, 2008

(51) Int. Cl. H04N 7/18

(52) U.S. Cl. 348/148; 348/E07.085

(57) ABSTRACT

A driver observation system has a plurality of camera modules mounted to an exterior area of a vehicle for providing real time video images on an exterior area of the vehicle. A control mechanism is coupled to the plurality of camera modules to control operation of each of the plurality of camera modules and to switch between different camera modules for viewing. A display system coupled to the control mechanism to show the real time video images. A recording device is coupled to the control mechanism for storing the real time video images.

### RELATED APPLICATIONS

The present application is related to U.S. Pat. No. 7,380,951, issued on Jun. 3, 2008, in the name of the same inventor, and entitled, “DRIVER OBSERVATION SYSTEM AND METHOD THEREFOR” and is hereby incorporated herewith.

### FIELD OF THE INVENTION

The present invention relates to automobiles, and more specifically, to a system for enhancing the observation of a driver of a vehicle by extending the driver's point of vision to the corners of the vehicle by transmitting forward, side, and rear images from the corners of the vehicle to a location within the vision of the driver at the controls of the vehicle while also providing security against thief and vandalism to the vehicle.

### BACKGROUND OF THE INVENTION

With the ever increasing number of vehicles on the roads, streets and highways and the increasing number of larger vehicles, such as pick-up trucks, vans and sports utility vehicles, commonly known as SUVs, the ability of the driver of a vehicle, especially smaller vehicles such as sports cars and sedans, to see traffic conditions, whether on the side, in the rear or forward has been diminished. This is particularly so in those conditions where a driver is attempting to turn into an intersecting street, or back out of a parking spot, or trying to turn left from a turning lane across oncoming traffic. In all those instances the driver must extend the vehicle into traffic a sufficient length, usually almost half the length of the vehicle, so that the driver's line of vision covers the oncoming traffic. While most vehicles are equipped with rear view mirrors and there have been attempts to eliminate the “blind spot” behind the driver, the need to extend the driver's line of vision applies in all direction.

Likewise, because so many vehicles are already in use, there is a need to provide an enhancement or extension of the driver's line of vision to existing vehicles as well as those under manufacture. Such an enhancement would have broader application and use if it were relatively small and unobtrusive.

Therefore, a need exists to provide a device and method to overcome the above problem. The device and method needs to increase the line of vision of the driver to extended to the corners of the vehicle.

### SUMMARY

In accordance with one embodiment, a driver observation system is disclosed. The driver observation system has a plurality of camera modules mounted to an exterior area of a vehicle for providing real time video images on an exterior area of the vehicle. A control mechanism is coupled to the plurality of camera modules to control operation of each of the plurality of camera modules and to switch between different camera modules for viewing. A display system coupled to the control mechanism to show the real time video images. A recording device is coupled to the control mechanism for storing the real time video images.

In accordance with another embodiment of the present invention, a driver observation system is disclosed. The driver observation system has a plurality of camera modules. The plurality of camera modules comprises a plurality of exterior camera modules mounted to an exterior area of a vehicle for providing real time video images on an exterior area of the vehicle; and at least one interior camera module coupled to an interior area of the vehicle for providing real time video images of the interior area of the vehicle. A control mechanism is coupled to the plurality of camera modules to control operation of each of the plurality of camera modules and to switch between different camera modules for viewing. A display system is coupled to the control mechanism to show the real time video images. A plurality of proximity sensors is attached to the vehicle and to the control mechanism, wherein the plurality of proximity sensors will activate at least one of the plurality of camera modules when at least one of the plurality of proximity sensors is triggered. A recording device is coupled to the control mechanism for storing the real time video images.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an elevated perspective view of one embodiment of the camera module used in the present invention;

FIG. 2 is front perspective view of a vehicle showing the locations of the camera modules mounted thereon;

FIG. 3 is a magnified front view of the camera system used in the present invention mounted on the vehicle;

FIG. 4 is an elevated perspective view of the dashboard of the vehicle having a camera module and a monitoring and control system used in the present invention; and

FIG. 5 is a simplified functional block diagram showing the driver observation system of the present invention.

### DETAILED DESCRIPTION

Referring to the Figures, a driver observation system 10 is shown. The driver observation system 10 will provide an enhancement or extension of the driver's line of vision to existing vehicles as well as those under manufacture. The driver observation system 10 will increase the line of vision of the driver to extend to all corners of a vehicle. The driver observation system 10 will also serve as a security system for vehicle 22.

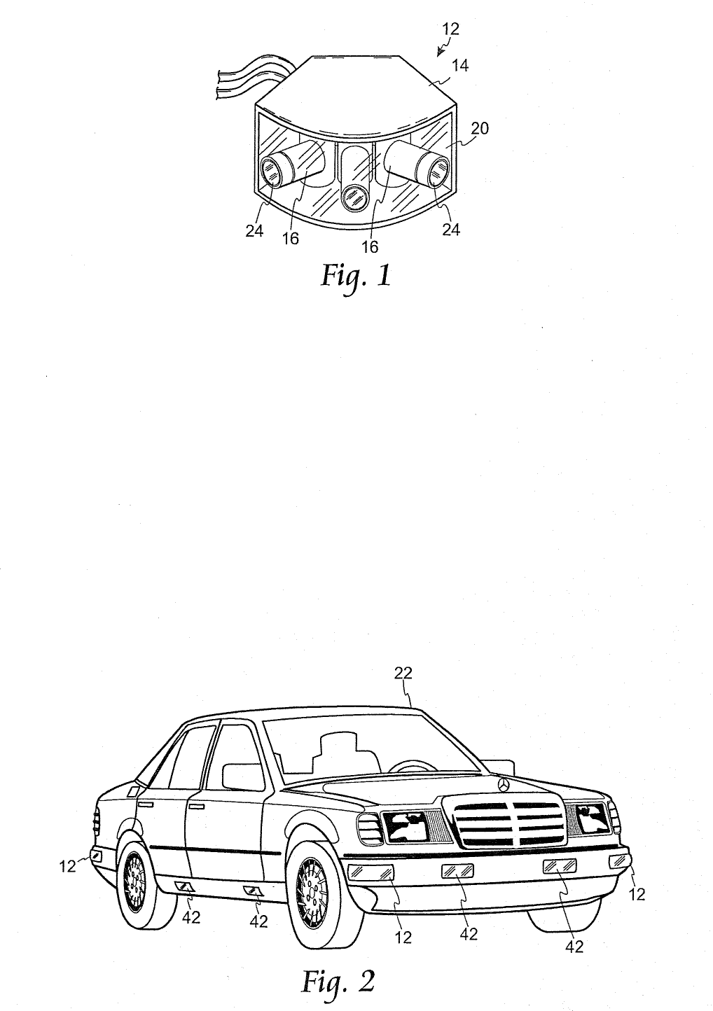

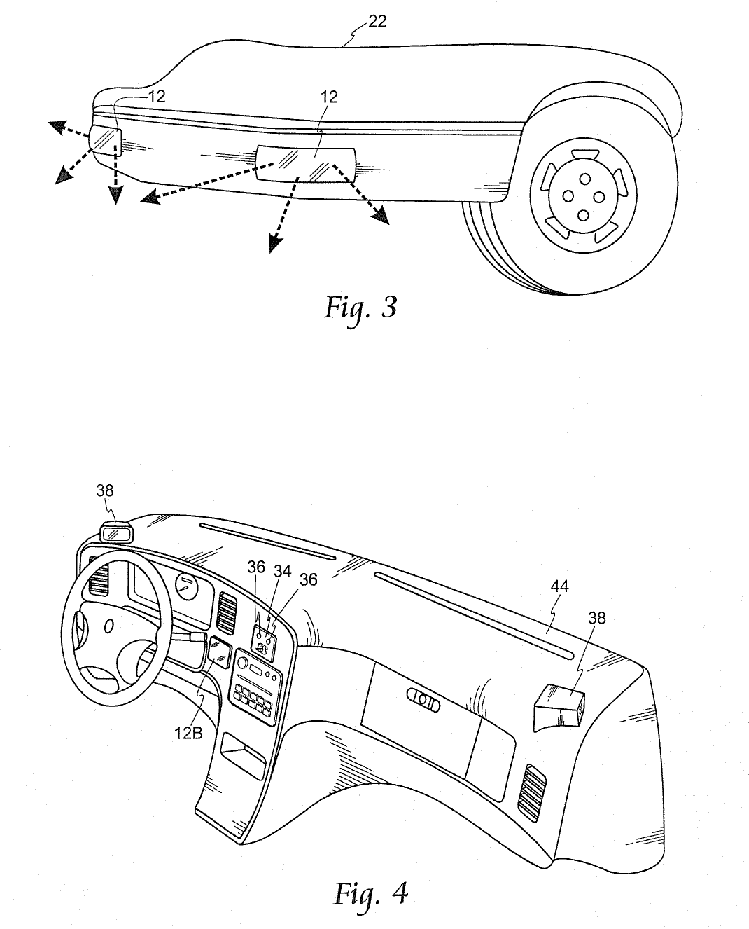

As shown in FIGS. 1-3, the driver observation system 10 has a plurality of camera modules 12. Each camera module 12 is mounted to the vehicle 22. In accordance with one embodiment, the vehicle 22 will have a plurality of external camera modules 12A which are mounted to an exterior surface of the vehicle 22 and at least one interior camera module 12B which is mounted to an interior area of the vehicle 22.

As shown in the Figures, the exterior camera modules 12A are generally mounted in the front and/or rear bumper of the vehicle 22. Preferably, the camera modules 12 are mounted on all four corners of the vehicle 22. For a more aerodynamic look, each camera module 12 is generally mounted inside the bumper of the vehicle 22 with the front face of the camera module 12 flush with the bumper. The above is given as an example. The camera module 12 may be mounted to other components and areas of the vehicle 22 without departing from the spirit and scope of the present invention. For example, the exterior camera modules 12A could be integrated into the existing headlight construction of the vehicle 22.

As stated above, at least one camera module 12 is mounted to an interior of the vehicle 22. The interior camera module 12A is generally mounted in a front interior section of the vehicle 22 and will be focused on the passenger area of the vehicle 22. As shown in FIG. 4, in accordance with one embodiment, the interior camera module 12B is mounted in the dashboard 44 of the vehicle 22.

Each camera module 12 will provide a real time video stream of an area in the direction of where the camera module 12 is pointed. By mounting multiple camera modules 12 around the exterior of the vehicle 22, one will increase the line of vision of the driver to extend to different areas of the vehicle 22. Also, the interior camera module 12B allows one to record real time video stream of those in the passenger compartment of the vehicle 22. This data may be used as a safety feature which will be discussed below.

As shown in FIG. 1 each camera module 12, both exterior camera modules 12A and interior camera module 12B, has a housing 14, a plurality of monitoring cameras 16, and a lens panel 20. The housing 14 is generally made of a lightweight but sturdy material such as plastic, aluminum or the like. The listing of the above is given as an example and should not be seen as to limit the scope of the present invention. The housing 14 is used to protect the components in the camera module 12 from damage. The housing 14 shown in the FIG. 1 is slightly conical in shape. However, the housing 14 may come in different shapes without departing from the spirit and scope of the present invention.

As stated above, in FIG. 1, the housing 14 is slightly conical in shape. The housing 14 has a rounded front section. The side walls 14A tapers down as the side walls moves towards the rear of the housing 14. The tapered shape of the housing 14 serves two purposes. First, the rounded front end allows the monitoring cameras 16 to have a wider viewing angle. This will allow the camera modules 12 to have a larger viewing area. The tapered housing 14 further allows one to more easily install the driver observation system 10 in an existing vehicle 22. The tapered rear section of the housing 14 will allow the housing 14 to more easily be positioned inside an existing bumper of a vehicle 22, dashboard, or other exterior/interior area of the vehicle 22.

The rounded front section of the housing 14 is covered by a lens panel 20. The lens panel 20 encloses the housing 14 to prevent damage to the components in the camera module 12. The lens panel 20 further reduces the glare from the sun and other light sources. The lens panel 20 may have a tint, coating, or the like to reduce the glare from different light sources.

Located inside each housing 14 is a plurality of monitoring cameras 16. The monitoring cameras 16 will provide real time video stream of an area where the monitoring camera 16 is pointed. Any type of monitoring camera may be used. In accordance with one embodiment, a fiber-optic camera is used as these types of cameras require less space and are easier to conceal. The monitoring camera 16 may have an adjustable lens 24 mounted thereon. The adjustable lens 24 will allow one to magnify or de-magnify (i.e., zoom in or zoom out) to get a clearer image of an area. Alternatively, a wide angle lens may be placed on the monitoring camera 16. A wide angle lens will generate a larger viewing area. Thus, a larger area can be monitored using a wide angle lens.

Each monitoring camera 16 is mounted inside the housing 14. Each monitoring camera 16 is stationary and does not move. Each monitoring camera 16 is mounted so that the combination of monitoring cameras 16 in a respective camera module 12 will provide a continuous field of view for the entire viewing area of the respective camera module 12. Thus, the field of view from each monitoring camera 16 will slight overlap to provide a continuous view with no missing gaps. Also, by providing a continuous view, when the picture from a first monitoring camera 16 is switched to an adjacent monitoring camera 16, it will look like as if a single monitoring camera 16 is panning over. This will be described further below.

Each camera module 12 is coupled to a control mechanism 30. The control mechanism 30 has several purposes. First, the control mechanism 30 allows one to adjust the focus and magnification of each monitoring camera 16. Second, the control mechanism 30 will allow a person to select the number of active monitoring cameras 16 and to switch between different monitoring camera(s) 16 in each camera module 12. Third, the control mechanism will allow one to switch between different camera modules 12. Thus, a driver can select one or more monitoring cameras 16 to be active in each camera module 12, switch between the different monitoring cameras 16 in each camera module 12 as well as switch to a different camera module 12 (i.e., change from the camera module 12 in the front of the vehicle 22 to one in the rear of the vehicle based on the direction the vehicle 22 is traveling). The above listing is given as an example. The control mechanism 30 may perform other features without departing from the spirit and scope of the present invention.

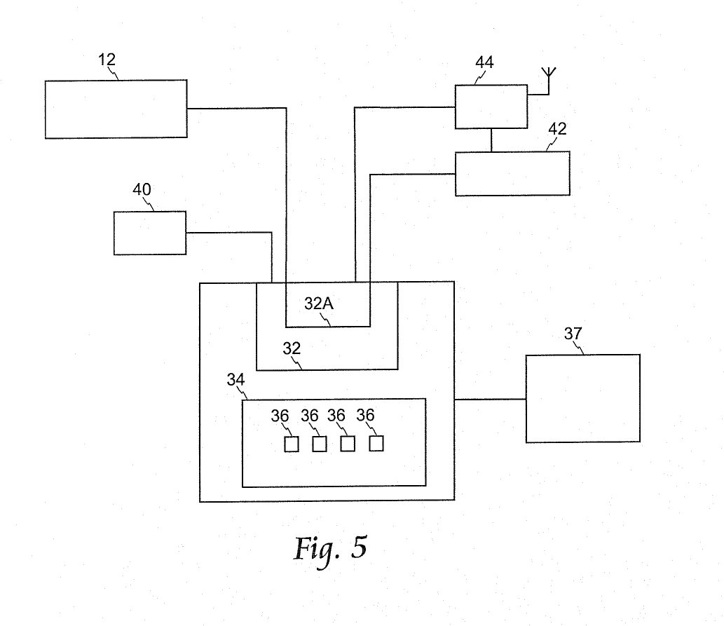

As shown in FIGS. 4 and 5, the control mechanism 30 is comprised of a control circuit 32 and a control panel 34. The control panel 34 is generally mounted in the vehicle 22. As shown in FIG. 4, the control panel 34 has a plurality of input devices 36. The input devices 36 will allow one to control the operation of each camera module 12 and the monitoring cameras 16 in each camera module 12. The input devices 36 will generally be buttons, switches, toggles switches, and the like. The listing of the above is given as examples and should not be seen as to limit the scope of the present invention. The input devices 36 allow one to select the number of monitoring cameras 16 to be active in each camera module 12, switch between different camera modules 12, adjust the focus and/or magnification of the active monitoring camera(s) 16 in each camera module 12, and will allow a person to switch between different monitoring cameras 16 in each camera module 12. The above listing is given as an example. The control mechanism 30 may perform other features without departing from the spirit and scope of the present invention.

The input devices 36 are coupled to the control circuit 32. The control circuit 32 is generally comprised of a processor 32A. The processor 32A is programmed to allow one to adjust the position and focus of each monitoring camera 16 and will allow a person to switch between different monitoring cameras 16 through the use of the input devices 36. The processor 32A further edits the video stream from the different monitoring cameras 16. As stated above, a user may select to have all of the monitoring cameras 16 in a camera module 12 active. Thus, the processor 32A will merge the video stream from each of the active monitoring cameras 16 and form a single video stream that provides a continuous field of view for the entire viewing area of the respective camera module 12. If the user only selects one monitoring camera 16, since the video stream from each monitoring camera 16 will slight overlap, when the video stream from a first monitoring camera 16 is switched to an adjacent monitoring camera 16, the processor will merger the video stream to look as if the video stream is been shifted like the monitoring camera 16 is panning over.

The real time video stream and/or modified video stream by the processor 32A are shown on a display system 37. The display system 37 is generally mounted inside the vehicle 22 in which the driver observation system 10 is installed. In general, the display system 37 is generally comprised of one or more video monitors 38 which are mounted on the dash 44 of the vehicle 22. A video monitor 38 is generally mounted on both the left and right side of the dashboard 44.

The control mechanism 30 may allow one to control the images on the display system 37. For example, the video monitor 38 may be split to show images from all of the camera modules 12. Alternatively, the video monitor 38 may show images from multiple or a single monitoring camera 16. The control mechanism 30 will allow the user to toggle between different monitoring cameras 16 and/or camera modules 12 which will be displayed on the video monitor 38. In accordance with another embodiment, a pair of video monitors 38 may be installed in the vehicle 22. The video monitors 38 will generally be mounted on each side of the dashboard of the vehicle 22. In general, the video monitor 38 on the right side will display images from the front and back of the vehicle 22 on the passenger's side, while video monitor 38 on the left side will display images from the front and back of the vehicle 22 on the driver's side. As discussed above, the video monitors 38 may be split to show images from all of the monitoring cameras 16 and/or camera modules 12. Alternatively, the video monitor 38 may just show images from individual or multiple monitoring cameras 16. The control mechanism 30 will then allow the user to toggle between different monitoring cameras 16 which will be displayed on the video monitor 38.

A recording device 40 may be coupled to the processor 32A. The recording device 40 is used to store the video stream from the monitoring cameras 16 of the different camera modules 12. The recoding device 40 may be programmed to record the video stream from all the camera modules 12, only the active camera modules 12, the video stream that is displayed on the video monitor 38, and the like. The recording device 40 may further be used to record the video stream from the interior camera module 12B. This data may be used as evidence. For example, the recorded video stream may be used to show that the driver was handling the vehicle 22 in a proper manner during an accident, was driving in a proper manner if the vehicle 22 is a company vehicle, and the like. The above listing of the above video stream to be recorded and uses of the recorded video stream data is given as an example and should not be seen as to limit the scope of the present invention. In general, the control mechanism 30 may be used to program the recording device 40 as to which video stream is to be recorded.

The driver observation system 10 may further have proximity sensors/motion detectors 42 (hereinafter proximity sensors) located on the vehicle 22. The proximity sensors 42 are used to monitor a perimeter around the vehicle 22. When the vehicle 22 is turned off, the proximity sensors 42 will activate. If a person comes within a predetermined distance of the vehicle 22, the proximity sensor 42 will send a signal to the processor 32A to active the camera module 12 closest to the proximity sensor 42 that was triggered. The interior camera module 12A may also be activated. The monitoring cameras 16 in the activated camera module 12 will send a video stream which will be recorded by the recording device 40. The recorded video stream may be used as evidence. For example, the recorded video stream may be used to identify individuals who may have vandalize the vehicle 22, stolen the vehicle 22, and the like.

A transmitter 44 may be coupled to the recording device 44 and the control circuit 30. The transmitter 42 will compress and transmit the video stream being recorded to a device such as a cellular phone, computer, laptop, personal digital assistant, and the like. Alternatively, the transmitter 42 will compress and transmit the video stream being recorded to a third party monitoring company. The control circuit 30 may be used to program when the transmitter 44 transmits video stream data.

For example, the transmitter 42 may be activated when the proximity sensor 42 sends the signal to the processor 32A to activate the camera module 12 closest to the proximity sensor 42 that has been tripped. An individual may receive the video stream in real time, such as on a cellular phone, to monitor the vehicle 22 to make sure no one is trying to steal/damage his vehicle 22. Alternatively, a parent may have video stream data from the interior camera module 12B sent to the parent's cellular phone/computer so that the parent may monitor a child's driving abilities. The listing of the above is only given as examples, and should not be seen as to limit the scope of the present invention. The transmitter 44 may transmit video stream data for many other reasons other than those described above.

The observation system 10 may further have a GPS unit 46. The GPS unit 46 may be coupled to the transmitter 42 or another transmitting antenna. The GPS unit 46 would further aid in vehicle recovery, accident reporting, and navigation.

While embodiments of the disclosure have been described in terms of various specific embodiments, those skilled in the art will recognize that the embodiments of the disclosure can be practiced with modifications within the spirit and scope of the claims.

What is claimed is:

1. A driver observation system comprising:
a plurality of camera modules mounted to an exterior area of a vehicle for providing real time video images on an exterior area of the vehicle;
a control mechanism coupled to the plurality of camera modules to control operation of each of the plurality of camera modules and to switch between different camera modules for viewing;
a display system coupled to the control mechanism to show the real time video images; and
a recording device coupled to the control mechanism for storing the real time video images.

2. A driver observation system in accordance with claim 1 further comprising at least one interior camera module mounted in an interior area of the vehicle for providing real time video images of the interior area of the vehicle.

3. A driver observation system in accordance with claim 1 further comprising a plurality of proximity sensors attached to the vehicle and to the control mechanism, wherein the plurality of proximity sensors will activate at least one of the plurality of camera modules when at least one of the plurality of proximity sensors is triggered.

4. A driver observation system in accordance with claim 1 further comprising a transmitter coupled to the control mechanism and to the recording device for transmitting the real time video images.

5. A driver observation system in accordance with claim 1 wherein each camera module comprises:
a housing, wherein a front area of the housing has a substantially opaque cover; and
a plurality of video cameras mounted in the housing.

6. A driver observation system in accordance with claim 5 wherein housing further comprises a tint applied to the lens cover to reduce glare from different light sources.

7. A driver observation system in accordance with claim 1 wherein the control mechanism comprises:
a control panel mounted in the vehicle, the control panel having a plurality of input devices; and
a control circuit coupled to the control panel to control operation of the camera modules and the display system.

8. A driver observation system in accordance with claim 1 wherein the display system comprises at least one display monitor.

9. A driver observation system comprising:
a plurality of camera modules, wherein the plurality of camera modules comprises:
a plurality of exterior camera modules mounted to an exterior area of a vehicle for providing real time video images on an exterior area of the vehicle; and
at least one interior camera module coupled to an interior area of the vehicle for providing real time video images of the interior area of the vehicle;
a control mechanism coupled to the plurality of camera modules to control operation of each of the plurality of camera modules and to switch between different camera modules for viewing;
a display system coupled to the control mechanism to show the real time video images;
a plurality of proximity sensors attached to the vehicle and to the control mechanism, wherein the plurality of proximity sensors will active at least one of the plurality of camera modules when at least one of the plurality of proximity sensors is triggered; and
a recording device coupled to the control mechanism for storing the real time video images.

10. A driver observation system in accordance with claim 9 further comprising a transmitter coupled to the control mechanism and to the recording device for transmitting the real time video images.

11. A driver observation system in accordance with claim 9 wherein each camera module comprises:
a housing, wherein a front area of the housing has a substantially opaque cover; and
a plurality of video cameras mounted in the housing.

12. A driver observation system in accordance with claim 11 wherein housing further comprises a tint applied to the lens cover to reduce glare from different light sources.

13. A driver observation system comprising:
a plurality of camera modules mounted to an exterior area of a vehicle for providing real time video images on an exterior area of the vehicle wherein each camera module comprises:
a housing, wherein a front area of the housing has a substantially opaque cover; and
a plurality of video cameras mounted in the housing;
a control mechanism coupled to the plurality of camera modules to control operation of each of the plurality of camera modules and to switch between different camera modules for viewing; and
a display system coupled to the control mechanism to show the real time video images;
wherein the control mechanism may merge the real time video images from each of the plurality of video cameras from a single camera module to form a merged video image to be shown on the display.

14. A driver observation system in accordance with claim 13 further comprising at least one interior camera module mounted in an interior area of the vehicle for providing real time video images of the interior area of the vehicle.

15. A driver observation system in accordance with claim 13 further comprising a plurality of proximity sensors attached to the vehicle and to the control mechanism, wherein the plurality of proximity sensors will active at least one of the plurality of camera modules when at least one of the plurality of proximity sensors is triggered.

16. A driver observation system in accordance with claim 13 further comprising a transmitter coupled to the control mechanism and to the recording device for transmitting the real time video images.

17. A driver observation system in accordance with claim 13 wherein the housing further comprises a tint applied to the lens cover to reduce glare from different light sources.

18. A driver observation system in accordance with claim 13 wherein the control mechanism comprises:
a control panel mounted in the vehicle, the control panel having a plurality of input devices; and
a control circuit coupled to the control panel to control operation of the camera modules and the display system.

19. A driver observation system in accordance with claim 13 wherein the display system comprises at least one display monitor.

20. A driver observation system in accordance with claim 13 further comprising a recording device coupled to the control mechanism for storing the real time video images.
